(19) United States
(12) Patent Application Publication
(10) Pub. No.: US 2010/0238086 A1
(43) Pub. Date: Sep. 23, 2010

(54) DOUBLE-RIDGED HORN ANTENNA HAVING HIGHER-ORDER MODE SUPPRESSOR

(75) Inventors: Jung-Ick Moon, Daejeon (KR); Soon-Soo Oh, Seoul (KR); Joung-Myoun Kim, Daejeon (KR); Soon-Ik Jeon, Daejeon (KR); Chang-Joo Kim, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejon (KR)

(21) Appl. No.: 12/709,852

(22) Filed: Feb. 22, 2010

(30) Foreign Application Priority Data
Mar. 17, 2009 (KR) 10-2009-0022561
Oct. 30, 2009 (KR) 10-2009-0104203

(51) Int. Cl. H01Q 13/02

(52) U.S. Cl. 343/786

(57) ABSTRACT

A double-ridged horn antenna having a higher-order mode suppressor includes a pair of upper and lower ridges arranged opposite to each other, each of the upper and lower ridges having an inner surface to guide electromagnetic waves and an outer surface arranged opposite to the inner surface; upper and lower flares fixedly attached to respective outer surfaces of the upper and lower ridges; left and right flares coupled to the upper and lower flares to form a rectangular cone structure; and metal conductors symmetrically positioned between the upper and lower ridges and the left and right flares.

### CROSS-REFERENCES TO RELATED APPLICATIONS

The present application claims priority of Korean Patent Application Nos. 10-2009-0022561 and 10-2009-0104203, filed on Mar. 17, 2009, and Oct. 30, 2009, respectively, which are incorporated herein by reference in their entirety.

### BACKGROUND OF THE INVENTION

Exemplary embodiments of the present invention relate to a double-ridged horn antenna; and, more particularly, to a double-ridged horn antenna having a higher-order mode suppressor configured to improve the radiation and broadband characteristics of the antenna.

A dual-ridged horn antenna, or dual-ridged waveguide, is an example of a linearly polarized antenna. A broadband horn antenna using ridges has been proposed in the early twentieth century, and is one of the widely used broadband antenna models to date.

FIGS. 1 to 3 are side, front, and top views of a conventional double-ridged broadband horn antenna, respectively. The operating principle of the conventional double-ridged broadband horn antenna 100 will be described with reference to FIGS. 1 to 3. The upper and lower flares 112A and 112B and the left and right flares 114A and 114B are configured to propagate an electric field in the horn and maintain the shape of the horn antenna 100. Energy inputted to the power connector 130 is transferred to the metal conductor 120, which is short-circuited to the upper ridge 110A. As a result, the upper ridge 110A is positively (+) charged, and the lower ridge 110B, which is connected with the ground surface of the power connector 130, is negatively (−) charged. The electric field established between the ridges 110 propagates toward the aperture of the horn. The distance between the upper and lower ridges 110A and 110B is increased according to exponential impedance transformation so that it gradually converges at the impedance of the horn aperture (broadband impedance matching).

Due to the structure of the ridged horn antenna, a very high electric field is established between the ridges 110, but a low electric field is established between the ridges 110 and the left and right flares 114A and 114B. This finding has caused development of a model making the left and right flares 114A and 114B unnecessary without significantly degrading the operation. Contrary to conventional horn antennas, the ridges 110 are mounted inside the horn for the purpose of increasing the operating frequency range of the horn antenna. Insertion of ridges lowers the start frequency, at which the basic mode (TE10 mode) is established, and increases the distance to higher-order modes, guaranteeing an even radiation pattern throughput broad bands. As used herein, higher-order modes refer to TE20 mode or higher. The TE20 mode is generally suppressed in a structure having left/right symmetry about the power feeder, and TE30 mode thus becomes the first higher-order mode. Considering this, the range from TE10 to appearance of TE30 may be thought to be the operating frequency range of the broadband horn antenna.

However, unlike other cases of calculating the operating frequency based on return loss, it has been noted that, in the case of actual ridged antennas, the closer to the upper frequency limit, the worst radiation pattern disturbance occurs. Research to solve this problem is in process.

U.S. Pat. No. 7,161,550 (issued Oct. 20, 2005, hereinafter, referred to as Reference 1), entitled “Dual- and quad-ridged horn antenna with improved antenna pattern characteristics” discloses dual- and quad-ridged horn antennas which have additional structures to improve radiation characteristics of broadband ridged horn antennas, and which employ magnetic material and grooves. Reference 1 does not disclose in detail the degree of improvement in radiation patterns made by corresponding horn antennas, making it difficult to quantify performance improvement. Even so, the simplification of structure for better marketability and the requirement of easy fabrication adversely affect the degree of improvement. Specifically, the performance and application of magnetic material critically influences the antenna radiation pattern, which adversely affects reproduction properties.

Suppression of TE30 mode means suppression of radiation pattern disturbance, and can lead to realization of antennas operating in a broader band than conventional double-ridged horn antennas. Therefore, a need exists for a structure for suppressing TE30 mode, which is suitable for a new antenna model having an improved operating band.

U.S. Pat. No. 4,692,723 (issued Jul. 8, 1985, hereinafter, referred to as Reference 2) and U.S. Pat. No. 4,890,117 (issued Dec. 26, 1989, hereinafter, referred to as Reference 3) disclose technology for removing higher-order modes by narrow bandpass dielectric filters (Reference 2) and technology for converting TM modes into TE modes at the power feeder of antennas (Reference 3). Although these technologies may be understood as background technologies, the technical features for removing or converting higher-order modes disclosed in References 2 and 3 are different from the problems occurring in the prior art, which the present invention seeks to solve, or novel features the present invention seeks to achieve.

### SUMMARY OF THE INVENTION

An embodiment of the present invention is directed to a double-ridged horn antenna having a higher-order mode suppressor, which can be conveniently mounted on a ridged waveguide and can suppress higher-order modes efficiently, thereby solving the problem of radiation pattern disturbance occurring in conventional broadband ridged horn antennas.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a double-ridged horn antenna having a higher-order mode suppressor includes: a pair of upper and lower ridges arranged opposite to each other, each of the upper and lower ridges having an inner surface to guide electromagnetic waves and an outer surface arranged opposite to the inner surface; upper and lower flares fixedly attached to respective outer surfaces of the upper and lower ridges; left and right flares coupled to the upper and lower flares to form a rectangular cone structure; and metal conductors symmetrically positioned between the upper and lower ridges and the left and right flares.

The double-ridged horn antenna having a higher-order mode suppressor may further include a power connector to supply the upper and lower ridges with electric current from an external power source; and a feeding conductor to transfer electric current supplied from an external power source through the power connector to the upper and lower ridges.

The metal conductors may be mounted so as to be short-circuited to the upper and lower flares.

The metal conductors may suppress propagation of a high electric field created between the upper and lower ridges and the left and right flares and conduct TE30 mode suppression and conversion to TE10 mode so that a radiation pattern close to TE10 mode is outputted from a horn aperture. The resulting double-ridged horn antenna having a higher-order mode suppressor can be conveniently mounted on a ridged waveguide and can efficiently suppress higher-order modes.

### BRIEF DESCRIPTION OF THE DRAWINGS

FIG. 1 is a side view of a conventional double-ridged broadband horn antenna.

FIG. 2 is a front view of a conventional double-ridged broadband horn antenna.

FIG. 3 is a top view of a conventional double-ridged broadband horn antenna.

FIG. 4 is a side view of a double-ridged horn antenna having a higher-order mode suppressor in accordance with an embodiment of the present invention.

FIG. 5 is a front view of a double-ridged horn antenna having a higher-order mode suppressor in accordance with an embodiment of the present invention.

FIG. 6 is a top view of a double-ridged horn antenna having a higher-order mode suppressor in accordance with an embodiment of the present invention.

FIG. 7 shows a radiation pattern on xz-plane when TE30 mode is inputted to a conventional double-ridged broadband horn antenna.

FIG. 8 shows a radiation pattern on xz-plane when TE30 mode is inputted to a double-ridged horn antenna having a higher-order mode suppressor in accordance with an embodiment of the present invention.

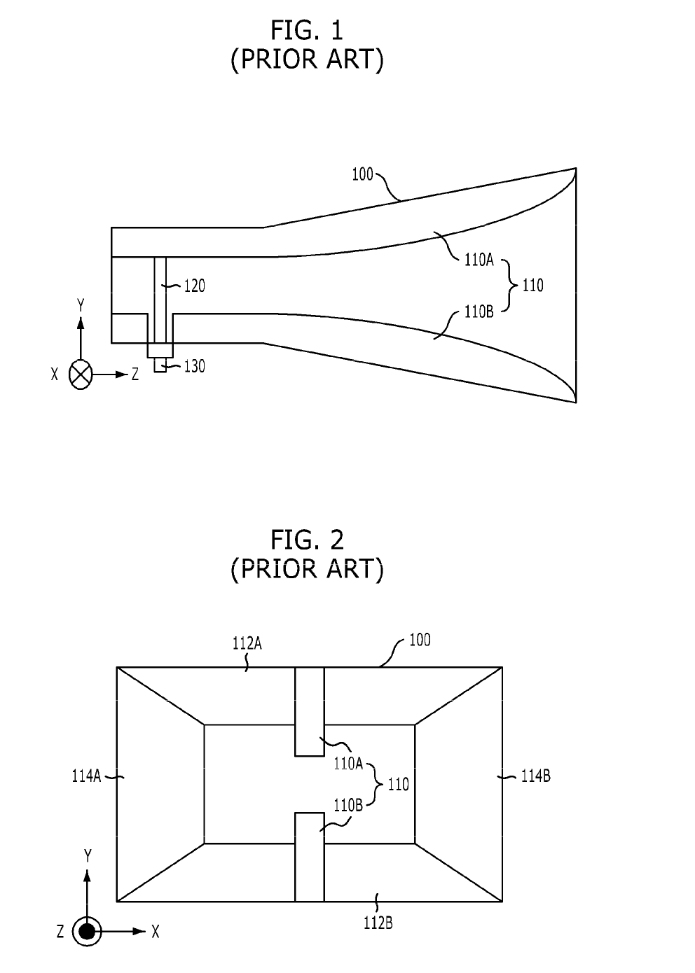

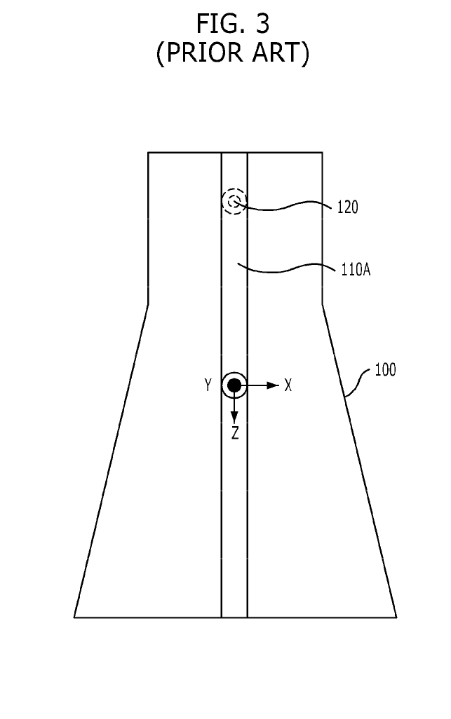

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, a dual-ridged horn antenna having a higher-order mode suppressor in accordance with a specific embodiment of the present invention will be described in detail with reference to the accompanying drawings.

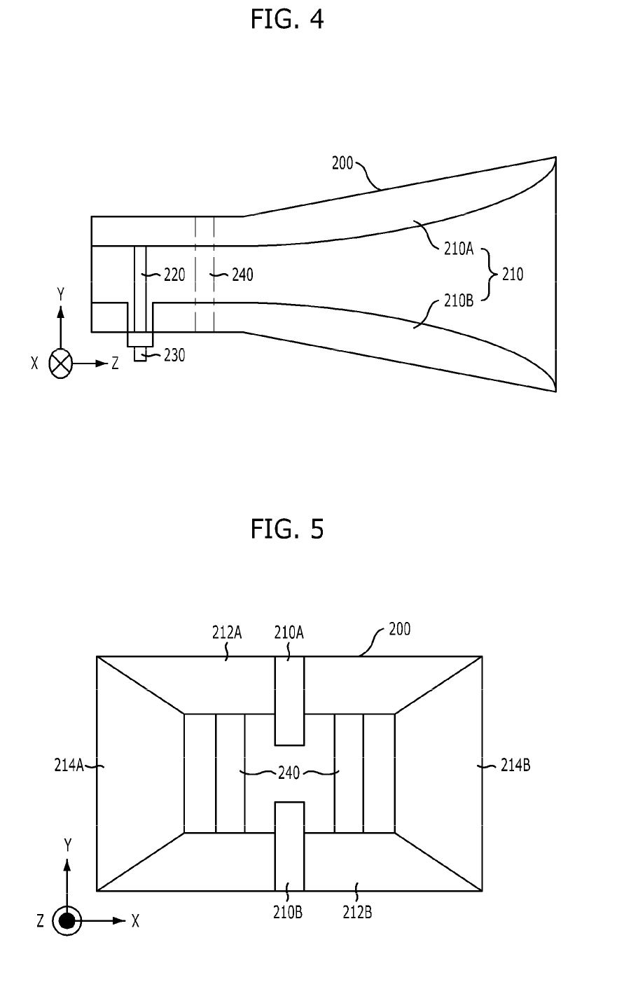

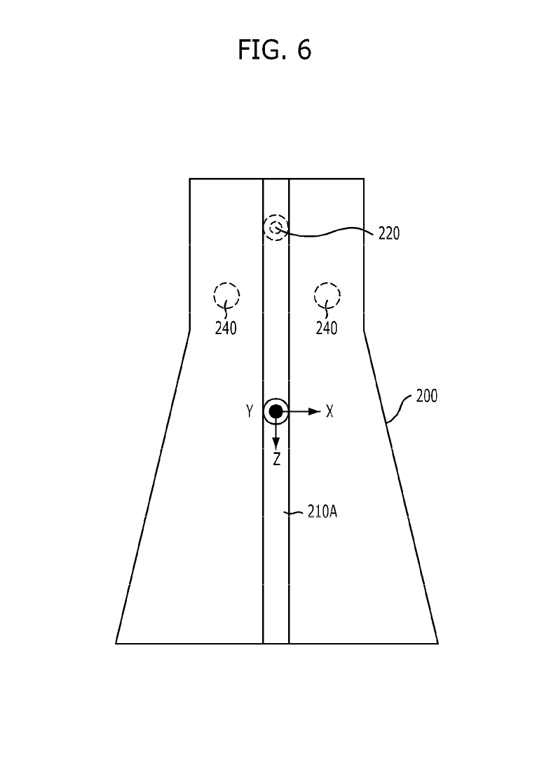

FIG. 4 is a side view of a double-ridged horn antenna having a higher-order mode suppressor in accordance with the present invention. FIG. 5 is a front view of a double-ridged horn antenna having a higher-order mode suppressor in accordance with the present invention. FIG. 6 is a top view of a double-ridged horn antenna having a higher-order mode suppressor in accordance with the present invention.

Referring to FIGS. 4 to 6, a double-ridged horn antenna 200 having a higher-order mode suppressor in accordance with the present invention includes a pair of ridges 210, specifically upper and lower ridges 210A and 210B arranged opposite to each another within a rectangular horn antenna. Each of the upper and lower ridges 210A and 210B may have a substantially convex inner surface and a substantially straight outer surface. In most cases, each outer surface may be fixedly attached to one of the upper and lower flares 212A and 212B and the left and right flares 214A and 214B, which constitute the horn antenna 200. When coupled together, the upper and lower flares 212A and 212B and the left and right flares 214A and 214B may form a rectangular cone structure having a substantially larger aperture than the base. In some cases, a rectangular box (or “cavity structure”) may be coupled to the base in a similar shape. The cavity structure may include a power connector 230 for supplying electric current from a power source (not shown) to the ridges 210 via a coaxial transmission line (not shown).

A feeding conductor 220 may also be provided to transfer electric current from the coaxial transmission line to the ridges 210 of the horn antenna 200. The transition from the coaxial transmission line to the feeding conductor 220 is an important part of the horn antenna in that it includes part of the feed region of the horn antenna (i.e., the location at which power is supplied to the ridges). When power is supplied, the inner surfaces of the ridges function as tapered waveguides to guide the radiated energy as it travels from base, through the “throat” of the horn antenna 200, and out through the “mouth” or aperture of the antenna 200.

The higher-order mode suppressor of the double-ridged horn antenna 200 in accordance with the present invention is characterized in that, as shown in FIGS. 4 to 6, metal conductors 240 are symmetrically positioned between the upper and lower ridges 210A and 210B and the left and right flares 214A and 214B of the double-ridged waveguide. The metal conductors 240 are mounted so that they are short-circuited to the upper and lower flares 212A and 212B. The electric field created by the feeding conductor 220 propagates in TE10 mode, but if the frequency is high, TE10 and TE30 modes coexist. A high electric field is created between the upper and lower ridges due to the characteristics of the double-ridged structure, but a low electric field is created between the ridges 210 and the left and right flares 214A and 214B and propagates in the TE10 mode. In the case of TE30 mode, a high electric field is created between the ridges 210 and the left and right flares 214A and 214B and propagates.

Therefore, insertion of the metal conductors 240 between the ridges 210 and the left and right flares 214A and 214B to suppress propagation not only results in suppression of TE30 mode, but also causes conversion to TE10 mode, so that a radiation pattern close to TE10 mode is outputted from the aperture of the horn.

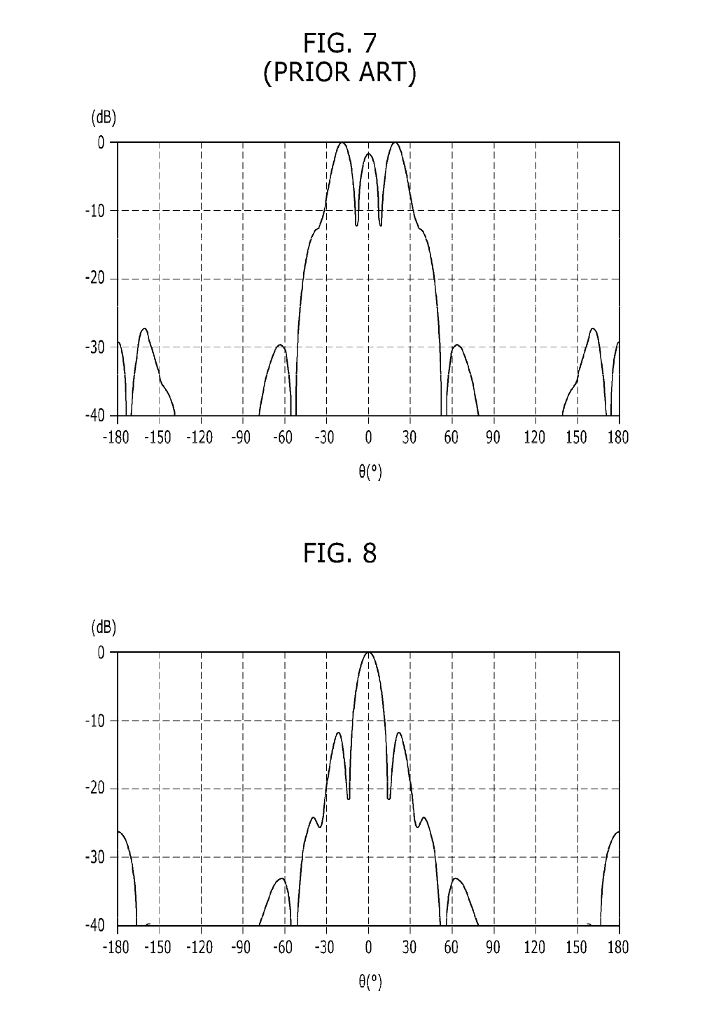

The degree of improvement in radiation pattern disturbance by the double-ridged horn antenna 200 having a higher-order mode suppressor in accordance with the present invention shown in FIGS. 4 to 6 is illustrated in FIGS. 7 and 8.

FIG. 7 shows a radiation pattern on xz-plane when TE30 mode is inputted to a conventional double-ridged broadband horn antenna. FIG. 8 shows a radiation pattern on xz-plane when TE30 mode is inputted to a double-ridged horn antenna having a higher-order mode suppressor in accordance with the present invention. In FIGS. 7 and 8, the horizontal axis denotes angular change 8 with reference to the Z-axis shown in FIG. 6. An angular change 8 in the X-axis direction with reference to the Z-axis, i.e. counterclockwise direction, has a positive value, and a clockwise angular change θ has a negative value. The unit of angular change is degree (°). The vertical axis in each drawing denotes the intensity of radio waves emitted by the double-ridged horn antenna, specifically the change of intensity assuming a maximum value of 0 (decibel unit).

It is clear from FIGS. 7 and 8 that the double-ridged horn antenna having a higher-order mode suppressor in accordance with the present invention suppresses TE30 mode, which occurs in conventional double-ridged broadband horn antennas, and improves radiation pattern disturbance so that the antenna can operate in a broader band.

In accordance with the exemplary embodiments of the present invention, the double-ridged horn antenna having a higher-order mode suppressor is advantageous in that it can suppresses TE30 mode, which occurs in conventional double-ridged broadband horn antennas, and improve radiation pattern disturbance so that the antenna can operate in a broader band.

In addition, the inventive double-ridged horn antenna has a simple structure so that it can not only be mounted conveniently on the ridged waveguide of a conventional double-ridged broadband horn antenna, but can also be manufactured easily whiling guaranteeing radiation pattern improvement.

While the present invention has been described with respect to the specific embodiments, it will be apparent to those skilled in the art that various changes and modifications may be made without departing from the spirit and scope of the invention as defined in the following claims.

What is claimed is:

1. A double-ridged horn antenna having a higher-order mode suppressor, comprising:
a pair of upper and lower ridges arranged opposite to each other, each of the upper and lower ridges having an inner surface to guide electromagnetic waves and an outer surface arranged opposite to the inner surface;
upper and lower flares fixedly attached to respective outer surfaces of the upper and lower ridges;
left and right flares coupled to the upper and lower flares to form a rectangular cone structure; and
metal conductors symmetrically positioned between the upper and lower ridges and the left and right flares.

2. The double-ridged horn antenna of claim 1, further comprising:
a power connector to supply the upper and lower ridges with electric current from an external power source; and
a feeding conductor to transfer electric current supplied from an external power source through the power connector to the upper and lower ridges.

3. The double-ridged horn antenna of claim 2, wherein the metal conductors are mounted so as to be short-circuited to the upper and lower flares.

4. The double-ridged horn antenna of claim 3, wherein the metal conductors suppress propagation of a high electric field created between the upper and lower ridges and the left and right flares and conduct TE30 mode suppression and conversion to TE10 mode so that a radiation pattern close to TE10 mode is outputted from a horn aperture.
